(19) United States
(12) Patent Application Publication
(10) Pub. No.: US 2008/0214048 A1
(43) Pub. Date: Sep. 4, 2008

(54) ISOLATION CAP STRUCTURE FOR ANTENNA CONNECTOR

(75) Inventor: HSI-CHUAN WONG, TAIPEI (TW)

Correspondence Address: T-CONN PRECISION CORPORATION, P.O.BOX 11192, TAIPEI,, 10099, TW

(73) Assignee: T-CONN PRECISION CORPORATION, BANCIAO (TW)

(21) Appl. No.: 11/307,511

(22) Filed: Feb. 10, 2006

(30) Foreign Application Priority Data
Dec. 30, 2005 (TW) 094223206

(51) Int. Cl. H01R 13/40

(52) U.S. Cl. 439/596

(57) ABSTRACT

An isolation cap structure for an antenna connector is disclosed. The isolation cap structure is made of an injection molded plastic material and has a sleeve, a back plate rotatably connected to one end portion of the sleeve and a clamping portion rortatably connected to one end portion of the back plate. A hole is formed at the center of the sleeve, and two bumps are disposed at the back side of the sleeve for embedding the back plate and allowing the clamping portion to flip down to clamp the wires. Thus, the isolation cap structure can be held conveniently and quickly in position with wire terminals. Because of the elastic property of the injection molded plastic material, the isolation cap structure is capable of restraining the unplugging/plugging forces and therefore the reliability and the durability of the isolation cap can be effectively promoted.

This application claims the priority benefit of a Taiwan patent application No. 094223206 filed on Dec. 30, 2005.

### FIELD OF THE INVENTION

The present invention generally relates to an antenna connector, and more particularly to an isolation cap structure of an antenna connector capable of being quickly and conveniently assembled.

### DESCRIPTION OF RELATED ART

Conventional antenna connector mainly comprises a plurality of conducting terminals isolated by insulation material layer and a metal housing covering the isolation material layer. A coaxial cable is inserted and clamped at one end of the metal housing and electrically connected to the conducting terminals to complete the assembly of the antenna connector.

To meet the current trend of being light, slim, short and small of the latest electronic products, the volume of the antenna connector must also be correspondingly reduced. However, the assembly of small components of the small antenna connector is more complicated and cause problems such as prolonged assembling process and increase in assembly defects. Thus, not only the fabrication yield and throughput is reduced but also reliability of the antenna connector is reduced.

In view of above-mentioned problems, it is highly desirable to develop an isolation cap structure of antenna connector that can be assembled quickly by using a simple assembling procedure such that not only the fabrication yield and throughput are promoted but also the reliability of the antenna connector can be effectively promoted.

### SUMMARY OF THE INVENTION

The present invention is directed to an isolation cap structure of an antenna connector that can be assembled quickly by using a simple assembling procedure.

The isolation cap structure of antenna connector of the present invention facilitates the subsequent assembly procedures.

According to an aspect of the present invention, an isolation cap comprised of an injection molded plastic material is provided. The isolation cap comprises a sleeve, a back plate and a clamping portion, wherein the sleeve, the back plate and the clamping portion are movably interconnected in series. A hole is disposed at the center of the sleeve and two bumps are disposed at the back side of the sleeve adopted for embedding the back plate and allow the clamping portion to flip down towards the clamp wires. Thus, the isolation cap can be assembled quickly and held conveniently in position with wire terminals. Therefore, the reliability as well as the durability of the antenna connector can be effectively promoted as the antenna connector of the present invention restrains the unplugging/plugging forces due to the elastic property of the isolation cap.

Other features and embodiments of the present invention can be further understood from the following detailed descriptions, with reference to the accompanied drawings.

### BRIEF DESCRIPTION OF THE DRAWINGS

FIG. 1 shows a perspective view of an isolation cap structure of antenna connector according to one embodiment of the present invention.

FIG. 2 shows a perspective view of the isolation cap structure of antenna connector of FIG. 1 when viewed from the opposite side.

FIG. 3-5 show schematic sectional views illustrating the assembly of the isolation cap structure of the antenna connector according to an embodiment of the present invention.

FIG. 6 shows perspective view of components when assembled to a terminal according to an embodiment of the present invention.

FIG. 7 shows a perspective view of a terminal according to an embodiment of the present invention.

### DETAILED DESCRIPTION OF THE INVENTION

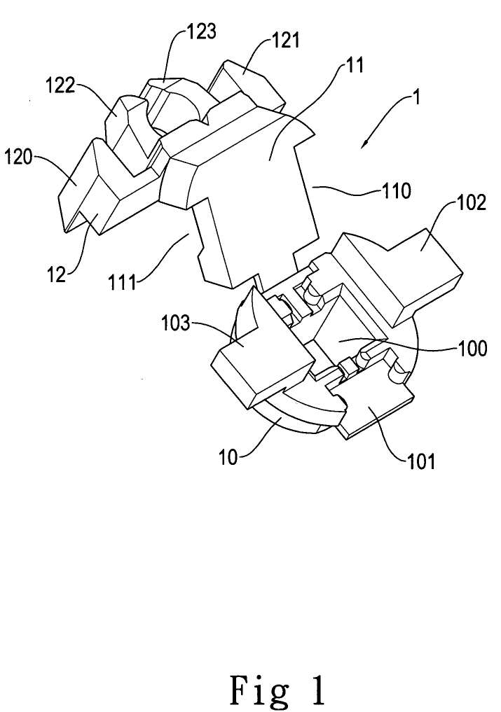

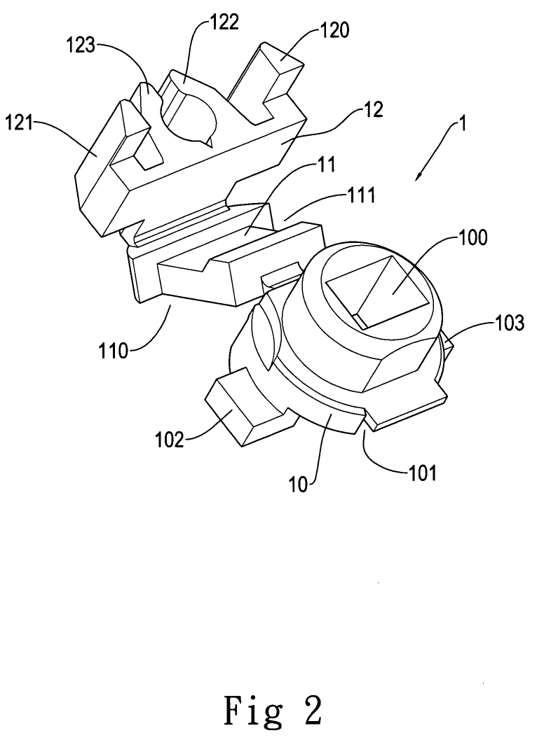

Referring to FIGS. 1 and 2, the isolation cap 1 of the present invention comprises a sleeve 10, a back plate 11 and a clamp portion 12. The sleeve 10, the back plate 11 and the clamp portion 12 comprise tabs for movably interconnecting with each other in series. A hole 100 piercing through the sleeve 10 is disposed at the center of the sleeve 10. One free end portion of the sleeve 10 is inserted into a groove 101. Two bumps 102 and 103 are disposed on two lateral sides of the sleeve 10 respectively. The isolation cap 1 is comprised of an injection molded plastic.

Connecting tabs are disposed on the front and back sides of the back plate 11 for linking to the sleeve 10 and the clamping portion 12. Grooves 110 and 111 corresponding to the bumps 102 and 103 are formed on two sides of the back plate 11.

Bump tabs 120 and 121 are disposed on the two lateral sides of the clamping portion 12, and two clamping tabs 122 and 123 are disposed between the bump tabs 120 and 121, wherein the free ends of the two clamping tabs 122 and 123 converge towards each other forming a contracted opening for holding.

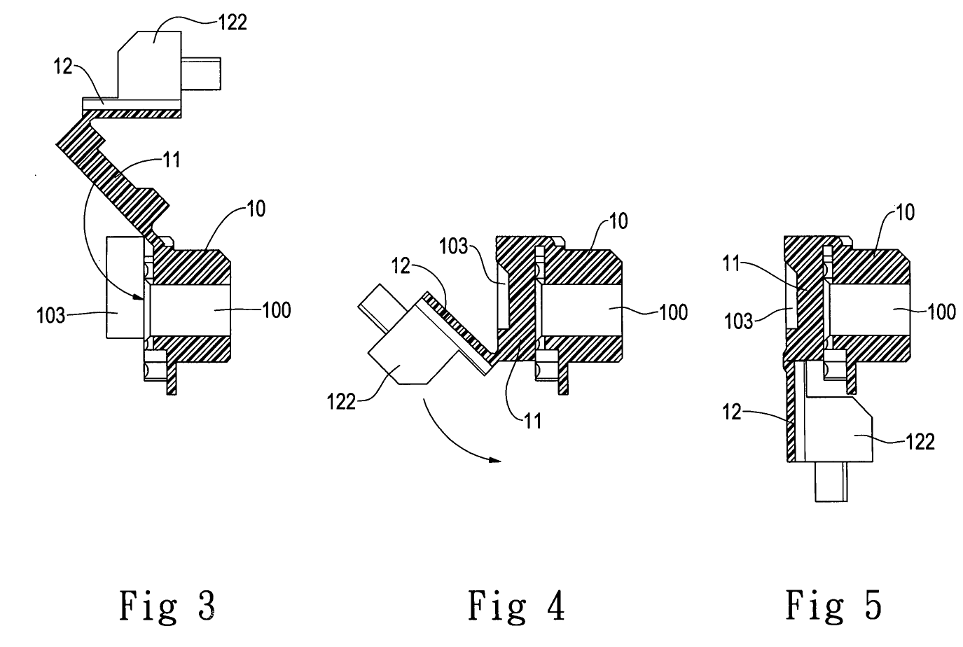

Referring to FIG. 3-5, the assembly of the isolation cap 1 is described as follows. First, the clamping portion 12 is positioned above the sleeve 10 and the back plate 11 is turned 180° towards the sleeve 10 and the clamping portion 12 turned to clamp the two bumps 102 and 103 of the sleeve 10 into the two grooves 110 and 111 of the back plate 11 respectively (FIG. 1), and thereby firmly fix the back plate 11 to the back side of the sleeve 10. Thereafter, the clamping portion 12 turned about 180° to complete the assembly of the isolation cap of the present invention.

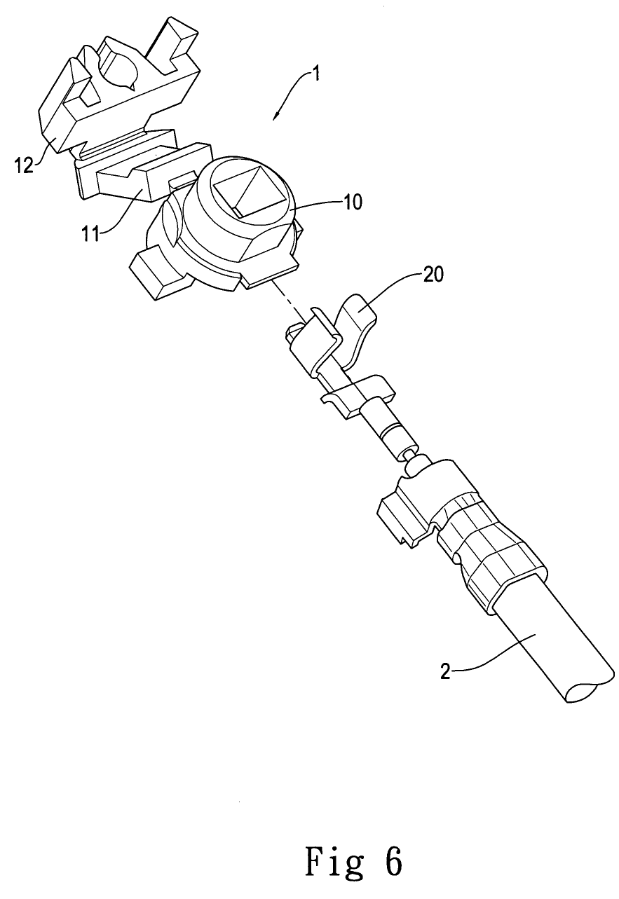

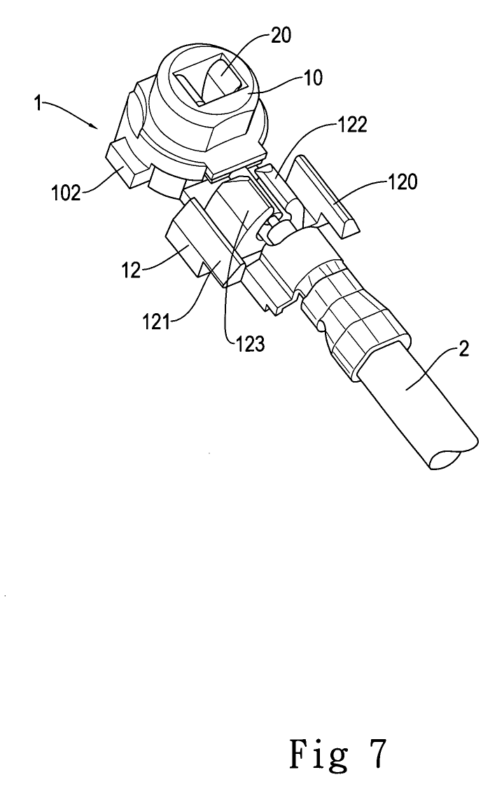

Referring to FIGS. 6 and 7, to electrically connect the terminals 20 of the wire 2 to the isolation cap of the present invention, the terminal 20 of the wire 2 is inserted into the hole 100 of the sleeve 10 and the wire 2 is pulled out from the groove 101 of the sleeve 10. Next, the sleeve 10 is clamped to the back plate 11 to firmly secure the terminal 20 and position within the hole 100 of the sleeve 10. Next, the clamping portion 12 is turned downwards until the clamping tabs 122 and 123 clinch the wire 2 therein. Thus, the terminal 20 of the wire is electrically connected to the isolation cap 1.

Accordingly, the isolation cap structure of the present invention at least has the following advantages.

The isolation cap is comprised of an injection molded plastic, and therefore the elasticity of the isolation cap may effectively restrain the plugging/unplugging force and thereby promote the reliability and durability of the antenna connector.

Because the back plate and the clamping portion are movably interconnected, assembly of the sleeve can be accomplished by a simple assembly procedure.

The above-mentioned illustrations represent only preferred embodiments of the present invention, all equivalent design variations in accordance with the claims in the present invention fall within the technical range of the present invention.

In summary, the present invention can achieve the expected objects of invention, providing an isolation cap for antenna connector, offering valuable uses in practice, hence hereby filing the application of patent for the present invention according to relevant laws.

1. An isolation cap structure for an antenna connector, comprising:
a back plate;
a sleeve, pivotally connected to one end of the back plate, comprising a hole at a center and two bumps disposed on two lateral sides thereof; and
a clamping portion, pivotally connected to another end of the back plate, wherein the sleeve can be pivoted over a first surface of the back plate and to position the back plate between the two bumps, and the clamping portion can be pivoted over a second surface of the back plate opposite to the first surface and to clamp wires such that the isolation cap can be held quickly in position with wire terminals, and wherein the isolation cap structure is comprised of an injection molded plastic material capable of restraining plugging/unplugging forces.

2. The isolation cap structure for an antenna connector according to claim 1, wherein a groove is disposed at an end portion of the sleeve opposite to an end portion comprising a connecting tab.

3. The isolation cap structure for an antenna connector according to claim 1, wherein grooves corresponding to the bumps of the sleeve are disposed on two lateral sides of the back plate.

4. The isolation cap structure for an antenna connector according to claim 1, wherein two bump tabs are disposed on two sides of the clamping portion and two clamping tabs are disposed between the two bump tabs.

5. The isolation cap structure for an antenna connector according to claim 1, wherein free end portions of the two clamping tabs converge towards each other forming a contracted opening.
